(19) United States
(12) Patent Application Publication
(10) Pub. No.: US 2026/0098825 A1
(43) Pub. Date: Apr. 9, 2026

(54) INSPECTION APPARATUS AND INSPECTION METHOD

(71) Applicant: Taiwan Semiconductor Manufacturing Company, Ltd., Hsinchu (TW)

(72) Inventors: Ding-Shiun TU, Hsinchu (TW); Kuang-Shing CHEN, Hsinchu (TW); Xiaomeng CHEN, Hsinchu (TW); Chien-Li WU, Hsinchu (TW)

(73) Assignee: Taiwan Semiconductor Manufacturing Company, Ltd., Hsinchu (TW)

(21) Appl. No.: 19/053,754

(22) Filed: Feb. 14, 2025

Related U.S. Application Data
(60) Provisional application No. 63/705,164, filed on Oct. 9, 2024.

(51) Int. Cl. G01N 23/2251

(52) U.S. Cl. CPC G01N 23/2251; G01N 2223/6116; G01N 2223/646

(57) ABSTRACT

An embodiment corresponds to an inspection apparatus that includes an electron beam source configured to emit an electron beam, and an objective lens set configured to project, based on the electron beam, an electron beamlet onto a target area. The inspection apparatus further includes a detector between the objective lens set and the target area and configured to detect backscattered electrons beamlets from the target area. The detector includes a substrate having an opening through which the electron beamlet passes, a plurality of sensing cells disposed on the substrate and surrounding the opening. Each sensing cell of the plurality of sensing cells has a normal direction tilted with respect to a normal direction of the substrate.

### PRIORITY CLAIM AND CROSS-REFERENCE

This patent application claims the benefit of U.S. Provisional Patent Application No.: 63/705,164 filed on Oct. 9, 2024, the entire disclosure of which is hereby incorporated by reference.

### BACKGROUND

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing are needed. In the course of integrated circuit evolution, functional density (i.e., the number of interconnected devices per chip area) has generally increased while geometry size (i.e., the smallest component (or line) that can be created using a fabrication process) has decreased.

Fabricating ICs typically includes processing a substrate such as a semiconductor wafer through a large number of fabrication processes to form various features and devices. Substrates are put through hundreds of fabrication processes, which may include, but are not limited to, lithographic processes, plasma etching, wet etching, chemical vapor deposition (CVD), physical vapor deposition (PVD), sputter deposition, chemical-mechanical polishing (CMP), ion implantation, annealing, variations thereof, and the like.

There is an ongoing demand for progressively higher device density. As a result, some fabrication processes may be operated close to the limits of their capabilities. Due to the high number of devices that are processed and the pushing of process limits, a portion of the manufactured devices based on the same semiconductor wafer may include defects or imperfections. To assure quality, manufacturers perform inspections on finished devices (or wafers at various manufacturing stages) to identify those that fail to meet the manufacturer's standards. In some applications, such inspection may be performed based on an optical inspection device or an electron beam inspection device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a simplified block diagram of an electron beam inspection device, in accordance with some embodiments.

FIG. 2A is a cross-sectional view of two detectors usable in an electron beam inspection device, in accordance with some embodiments.

FIG. 2B is a bottom view of a detector usable in an electron beam inspection device, in accordance with some embodiments.

FIG. 2C is a cross-section view of a sensing cell in a detector usable in an electron beam inspection device, in accordance with some embodiments.

FIG. 3A is a diagram of a grouping pattern example of arranging the electron beamlets of an electron beam inspection device in a spatial domain, in accordance with some embodiments.

FIGS. 3B-3D are timing diagrams of arrangement examples of arranging the electron beamlets of an electron beam inspection device in a time domain, in accordance with some embodiments.

FIG. 4 is a flowchart of a method of inspection, in accordance with some embodiments.

FIG. 5 is a flowchart of another method of inspection, in accordance with some embodiments.

### DETAILED DESCRIPTION

The following disclosure provides many different embodiments, or examples, for implementing different features of the provided subject matter. Specific examples of components and arrangements are described below to simplify this disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, this disclosure may repeat reference numerals and/or letters in the various examples. This repetition is for simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. In addition, the term “made of” may mean either “including” or “consisting of. ” In this disclosure, the phrase “one of A, B, and C” means “A, B, and/or C” (A, B, C, A and B, A and C, B and C, or A, B and C), and does not mean one element from A, one element from B, and one element from C, unless otherwise described.

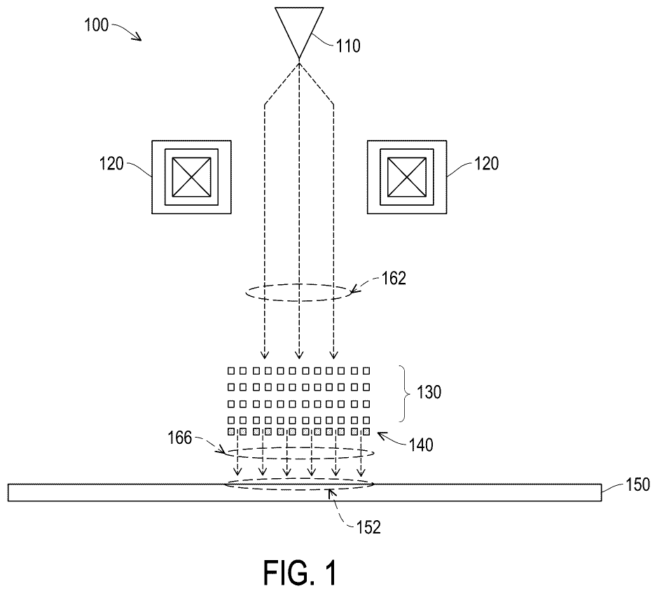

FIG. 1 is a simplified block diagram of an electron beam inspection device 100, in accordance with some embodiments. In some embodiments, electron beam inspection device 100 is a non-limiting example, and various components of electron beam inspection device 100 are simplified or omitted in FIG. 1.

In FIG. 1, electron beam inspection device 100 includes an electron beam source 110, a condenser lens 120, an objective lens set 130, and a plurality of detectors 140. In some embodiments, electron beam inspection device 100 is configured to inspect a sample (e.g., a wafer 150), based on projecting a plurality of electron beamlets onto a target area of the sample (e.g., a target area 152 of wafer 150) and detecting back-scattered electrons (BSE).

In some embodiments, electron beam source 110 is configured to emit an electron beam 162 (also referred to as a primary electron beam). In some embodiments, electron beam source 110 includes an electron generator or an electron gun. In some embodiments, for an inspection process based on detecting backscattered electrons, the energy of the electron beam 162 is at or greater than 3000 electron-volts (eV). In some embodiments, condenser lens 120 is configured to bend or shape electron beam 162 such that the electrons in electron beam 162 move toward objective lens set 130 in parallel. In some embodiments, condenser lens 120 includes one or more coils configured to generate a magnetic field for bending the trajectories of the electrons in electron beam 162.

In some embodiments, objective lens set 130 is configured to project, based on the electron beam 162, a plurality of electron beamlets 166 onto a target area (e.g., target area 152). In some embodiments, objective lens set 130 is capable of converting electron beam 162 into up to 100 or more electron beamlets 166. In some embodiments, objective lens set 130 includes a plurality of microelectron-mechanical system (MEMS) devices configured as deflecting devices and/or beam stopping devices in association with the plurality of electron beamlets. In some embodiments, each one of the MEMS devices is associated with a corresponding electron beamlet of electron beamlets 166 and includes one or more layers of limiting apertures, an electron deflector, a stigmator, or a combination thereof.

In some embodiments, the plurality of detectors 140 is configured to detect backscattered electrons from the target area resulting from the interaction between electron beamlets 166 and the sample (e.g., wafer 150). In some applications, to detect the defects of the sample (e.g., wafer 150) based on detecting backscattered electrons, electron beam 162 is of a high energy level (e.g., greater than 3000 eV), hence the energy of the resulting backscattered electrons is still too high to be effectively redirected to a detector at an angle away from objective lens set 130. Accordingly, the plurality of detectors 140 is disposed between objective lens set 130 and the sample. In some embodiments, each detector of the plurality of detectors 140 is disposed in association with a corresponding electron beamlet of electron beamlets 166. In some embodiments, each detector of the plurality of detectors 140 includes an opening through which the associated electron beamlet passes. In some embodiments, each detector of the plurality of detectors 140 further includes one or more sensing cells configured to convert detected electrons into a voltage signal or a current signal.

In some embodiments, a processing device (not shown) is communicatively coupled to condenser lens 120 and/or objective lens set 130 to control the power, timing, and/or trajectories of plurality of electron beamlets 166. In some embodiments, the processing device or a different processing device (not shown) is communicatively coupled to the plurality of detectors 140 to collect the voltage or current signals representing electrons detected by the sensing cells thereof, and to obtain one or more scanning images based on processing the collected voltage or current signals.

In some embodiments, in a multi-electron beam inspection system based on electron beam inspection device 100, each one of the plurality of detectors 140 receives not only the backscattered electrons resulting from the electron beamlet associated thereto, but also other backscattered electrons resulting from neighboring electron beamlets. As such, the resulting image from each detector corresponds to a superposition of the backscattered electrons resulting from the associated electron beamlet as well as the neighboring electron beamlets, which is also referred to as a cross-talk effect or cross-talk noise. In some embodiments, the cross-talk noise interferes with the effectiveness of detecting the backscattered electrons corresponding to the defects of the sample (e.g., wafer 150).

In some applications, placing the sample (e.g., wafer 150) closer to the plurality of detectors 140 reduces the cross-talk noise (e.g., a distance less than 0.5 millimeters), but increases the chance of arcing between the plurality of detectors 140 and the sample and thus increases the chance of damaging the sample during the inspection process and/or renders the detection results unusable. In some applications, enlarging a pitch (e.g., greater than 50 micrometers, μm) between neighboring electron beamlets also reduces the cross-talk noise. However, in some applications, enlarging the pitch between neighboring electron beamlets reduces the throughput of the inspection process, as the covering range with respect to beam deflection is limited (e.g., a larger pitch corresponds to moving the sample and stage for scanning all the regions). In some embodiments, control of the cross-talk noise is a bottleneck of developing a multi-electron beam inspection system.

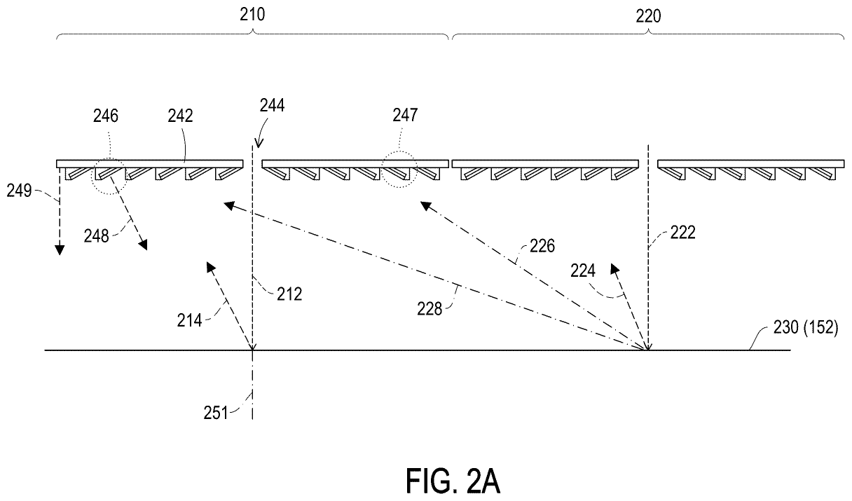

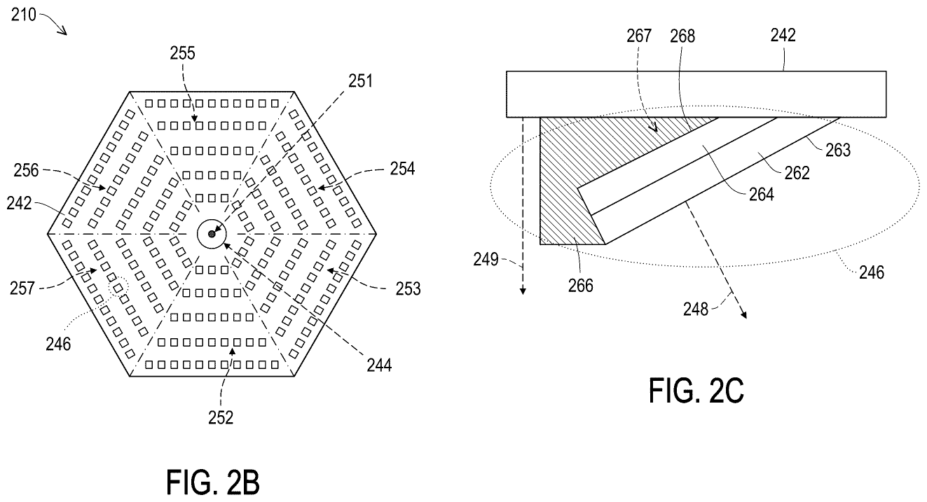

In some embodiments, to reduce the cross-talk noise based on a first concept, the sensing cells of detectors 140 are configured to collect backscattered electrons at specific angles. For example, a detector is based on an array of pixelated semiconductor sensing cells, and each one of the sensing surfaces of each sensing cell is tilted at a corresponding angle (e.g., ranging from 5 degrees to 45 degrees). As such, the backscattered electrons resulting from neighboring beamlets reach the sensing cells of a detector at the sides or backs of the sensing cells that are not suitable for effective electron detection, and the cross-talk noise is thus reduced. In this disclosure, FIGS. 2A-2C include non-limiting examples corresponding to the first concept.

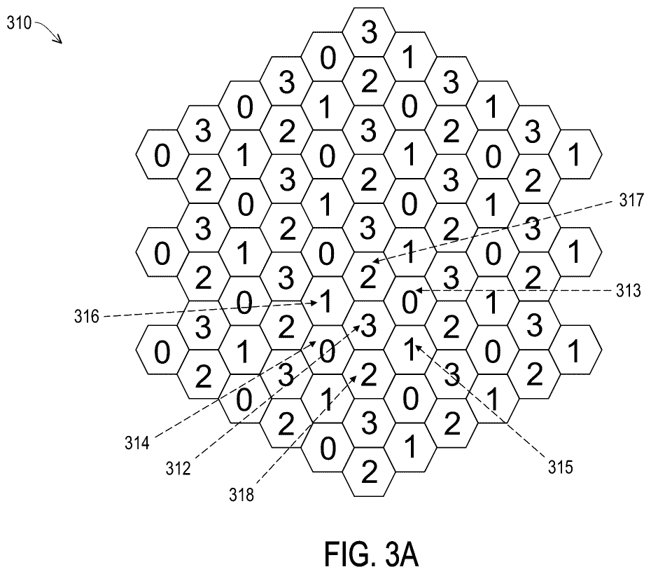

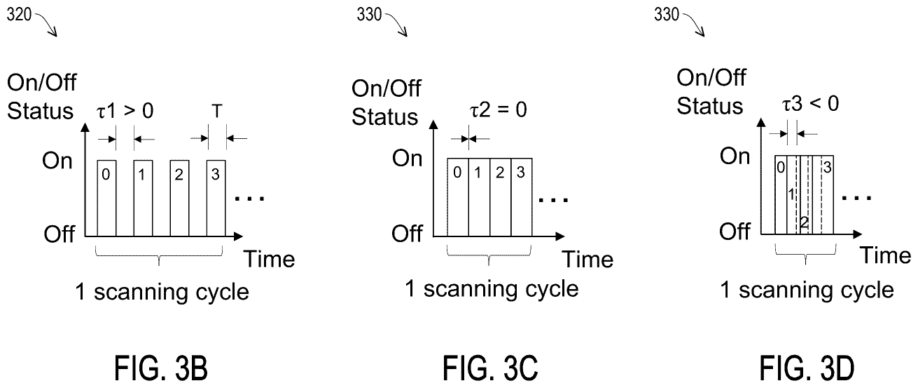

In some embodiments, to reduce the cross-talk noise based on a second concept, the electron beamlets 162 are pulsed electron beamlets that are spatially interleaved and temporally distinguishable with respect to one another. In some embodiments, objective lens set 130 is capable of individually controlling the switching of each electron beamlet to create pulsed electron beamlets. In some embodiments, in a case where the irradiation duration of neighboring electron beamlets are partially overlapped, the scanning image is improvable based on post-processing the detected signals to separate the detected electrons from different beamlets. In this disclosure, FIGS. 3A-3D include non-limiting examples corresponding to the second concept.

FIG. 2A is a cross-sectional view of two detectors 210 and 220 usable in an electron beam inspection device, in accordance with some embodiments. In some embodiments, detectors 210 and 220 are usable as detectors of electron beam inspection device 100 in FIG. 1. In FIG. 2A, detector 210 is between objective lens set 130 and target area 152 (e.g., an upper surface 230 of a wafer, such as wafer 150 in FIG. 1), configured to let an associated electron beamlet 212 through, and configured to detect backscattered electrons 214 from the target area. Also, detector 220 is between objective lens set 130 and target area 152 (e.g., upper surface 230), configured to let an associated electron beamlet 222 through, and detect backscattered electrons 224 from the target area. In some embodiments, all detectors of the plurality of detectors 140 of electron beam inspection device 100 are based on the same hardware configuration. Here, detector 210 is further illustrated below as a non-limiting example of plurality of detectors 140.

In FIG. 2A, detector 210 includes a substrate 242 that has an opening 244 through which the associated electron beamlet 212 passes. Detector 210 further includes a plurality of sensing cells (two of which are identified by circles with reference numbers 246 and 247) disposed on substrate 242 and surrounding opening 244. In some embodiments, each sensing cell of the plurality of sensing cells is based on the same hardware configuration. In some embodiments, each sensing cell of the plurality of sensing cells has a sensing direction that corresponds to a normal direction (e.g., direction 248) thereof tilted with respect to a normal direction 249 of substrate 242. In some embodiments, electron beamlet 212 passes through opening 244 along an axis 251 that is parallel with normal direction 249 of substrate 242. In FIG. 2A, each sensing cell of the plurality of sensing cells of detector 210 has a sensing surface facing the target area (e.g., target area 152, or the upper surface 230 of a wafer) and tilted toward the axis 251. In some embodiments, each sensing cell is tilted by an angle ranging from 5 degrees to 45 degrees.

FIG. 2B is a bottom view of a detector usable in an electron beam inspection device, in accordance with some embodiments. In some embodiments, the detector in FIG. 2B corresponds to detector 210 in FIG. 2A. Components in FIG. 2B that are the same or similar to those in FIG. 2A are given the same reference numbers, and detailed description thereof is thus simplified or omitted.

In FIG. 2B, detector 210 is configured to accommodate an electron beamlet (e.g., electron beamlet 212 in FIG. 2A) passing through opening 244 along axis 251 (identified by a dot representing a direction coming out of the sheet). In FIG. 2B, substrate 242 of detector 210 is divided into zones 252-257 surrounding opening 244. In some embodiments, the plurality of sensing cells (e.g., including sensing cells 246 and 247) has subsets of sensing cells disposed in corresponding ones of the zones 251-256 in a rotationally symmetric manner with respect to opening 244. In this non-limiting example, detector 210 includes six zones 252-257, and each zone includes five rows of sensing cells. In some embodiments, a number of zones surrounding opening 244 and a number of rows of sensing cells are different from the example of FIG. 2B.

FIG. 2C is a cross-section view of a sensing cell in a detector usable in an electron beam inspection device, in accordance with some embodiments. As a non-limiting example, the sensing cell in FIG. 2C corresponds to sensing cell 246 on substrate 242 in FIG. 2A. Components in FIG. 2C that are the same or similar to those in FIG. 2A are given the same reference numbers, and detailed description thereof is thus simplified or omitted. In some embodiments, each sensing cell of the plurality of sensing cells of detector 210 is based on the hardware configuration of the example in FIG. 2C. In some embodiments, each sensing cell in FIGS. 2A-2C is a solid-state sensing cell.

In FIG. 2C, sensing cell 246 includes a sensing diode (represented by block 262) that has a sensing surface 263 at a front portion of sensing cell 246. Sensing cell 246 further includes a signal pick-up circuit (represented by block 264) at a back portion of sensing cell 246. In addition, in FIG. 2C, sensing cell 246 includes an insulating seal 266 covering a side portion of sensing cell 246. In some embodiments, a gap 267 is defined between substrate 242 and a back surface 268 of signal pick-up circuit 264, and insulating seal 266 extends into gap 267 and covers the back surface 268 of signal pick-up circuit 264. In some embodiments, signal pick-up circuit 264 includes an amplification circuit or an operational amplifier. In some embodiments, insulating seal 266 includes a material including silicon oxide, silicon nitride, polymer, ceramic, epoxy, or a combination thereof. In some embodiments, sensing diode (represented by block 262) has a width ranging from 15 μm to 30 μm and has a thickness ranging from 5 μm to 10 μm. In some embodiments, signal pick-up circuit (represented by block 264) has a width ranging from 15 μm to 30 μm and has a thickness ranging from 5 μm to 10 μm.

In the non-limiting example according to FIGS. 2A-2C, each detector (e.g., detector 210) includes an array of pixelated tilted sensing cells (e.g., sensing cell 246 and sensing cell 247). In some embodiments, each one of the sensing cells is disposed on a substrate (e.g., substrate 242) with a tilted angle with respect to a normal direction (e.g., normal direction 249) of the substrate. According to FIGS. 2A-2C, the sensing surface (e.g., sensing surface 263) of each sensing cell is tilted toward an axis (e.g., axis) along which the trajectory of a corresponding electron beamlet is defined. In the example in FIG. 2A, the tilted sensing surface of each sensing cell of detector 210 is configured to receive backscattered electrons 214 resulting from the interaction between the sample and the associated electron beamlet 212.

Moreover, in the example in FIG. 2A, due to the tilted sensing surface, the sensing cells (e.g., sensing cell 247) of detector 210 that are disposed in a zone adjacent to detector 220 are not arranged to effectively collect backscattered electrons 226 resulting from the interaction between the sample and electron beamlet 222 associated with detector 220. In some embodiments, the insulating seals of the sensing cells with sensing surfaces facing away from the neighboring detectors (e.g., sensing cell 247 and adjacent sensing cells in the same zone of detector 210) are configured to protect the side portions and the back portions of the corresponding sensing cells from the backscattered electrons resulting from the neighboring electron beamlets.

Moreover, in the example in FIG. 2A, although the sensing cells (e.g., sensing cell 246) of detector 210 that are disposed in a zone farther away from detector 220 appear to be able to receive backscattered electrons 228 resulting from the interaction between the sample and electron beamlet 222, the overall amount of the backscattered electrons resulting from electron beamlet 222 is still significantly reduced, as only a portion of the sensing cells of detector 210 is disposed at such angle usable for receiving the large-angle backscattered electrons resulting from electron beamlet 222.

Accordingly, a detector that is usable in an electron beam inspection device based on the example in FIGS. 2A-2C has a reduced chance of receiving backscattered electrons resulting from neighboring electron beamlets. As such, the cross-talk noise detected by the detector (e.g., detector 210) of the electron beam inspection device is reduced. Also, based on the reduced cross-talk noise, the distance between the detectors and the sample is kept sufficiently away from the sample (e.g., a distance greater than 0.5 millimeters) in order to reduce the chance of arcing between the detectors and the sample without sacrificing the imaging quality.

FIG. 3A is a diagram of a grouping pattern example 310 of arranging the electron beamlets of an electron beam inspection device in a spatial domain, in accordance with some embodiments. In some embodiments, the electron beamlets (e.g., the plurality of electron beamlets 166 in FIG. 1) of an electron beam inspection device are divided into multiple groups of electron beamlets that are spatially interleaved and temporally distinguishable with respect to one another in order to reduce the chance of a detector picking up the backscattered electrons resulting from the neighboring beamlets.

In FIG. 3A, each hexagon represents a corresponding position of a detector of an electron beam inspection device (e.g. electron beam inspection device 100). As illustrated based on the example in FIG. 1, each detector is configured to be used in association with a corresponding electron beamlet. In some embodiments, each detector represented by a hexagon in FIG. 3A corresponds to a single sensing cell detector with an opening at the center through which the associated electron beamlet passes. In some embodiments, each detector represented by a hexagon in FIG. 3A corresponds to a detector with an array of tilted sensing cells (e.g., the example in FIGS. 2A-2C) or with an array of non-tilted sensing cells (e.g., a normal direction of the sensing cell being parallel with a direction of the trajectory of the associated electron beamlet). In this example, the detectors of the electron beam inspection device are arranged based on a hexagon honeycomb pattern.

In FIG. 3A, the numbers in the hexagons represent the grouping of the corresponding beamlets in the spatial domain. In some embodiments, an objective lens set (e.g., objective lens set 130 in FIG. 1) of the electron beam inspection device is configured to convert the primary electron beam (e.g., electron beam 162) into the electron beamlets (e.g., electron beamlets 166) that are spatially arranged based on centers of the hexagon honeycomb pattern of the detectors. As a result, the positions of the electron beamlets observable on the target area would correspond to vertices of a triangular tiling honeycomb pattern. In some embodiments, the groups of electron beamlets correspond to four groups, labeled by numbers 0, 1, 2, and 3 in FIG. 3A. In this non-limiting example, at least one electron beamlet of each one of the four groups is spatially surrounded by six electron beamlets of the other three of the four groups. For example, an electron beamlet corresponding to hexagon 312 belongs to group ‘3’, which is surrounded by six electron beamlets of other three groups, including two electron beamlets corresponding to hexagons 313 and 314 and belong to group ‘0’, two electron beamlets corresponding to hexagons 315 and 316 and belong to group ‘1’, and two electron beamlets corresponding to hexagons 317 and 318 and belong to group ‘2’.

Moreover, the objective lens set (e.g., objective lens set 130 in FIG. 1) of the electron beam inspection device is configured to convert the electron beam into the groups of electron beamlets such that each one of the groups of electron beamlets temporally begins at a different time. In some embodiments, during the time interval that the electron beamlets of one group is present, the presence of other groups is avoided or reduced in order to reduce the chance of a detector receiving cross-talk noise.

FIGS. 3B-3D are timing diagrams of arrangement examples of arranging the electron beamlets (e.g., the plurality of electron beamlets based on the example in FIG. 3A) of an electron beam inspection device in a time domain, in accordance with some embodiments. In FIGS. 3B-3D, time is represented by the horizontal axis, and the on/off status of the electron beamlets of each group is represented by the vertical axis. In this non-limiting example, the electron beamlets are divided into four groups (e.g., group ‘0’, group ‘1’, group ‘2’, and group ‘3’ in FIG. 3A) of pulsed electron beamlets. In some embodiments, the groups of electron beamlets sequentially begin one after another and sequentially end one after another. In some embodiments, each one of the groups of electron beamlets temporally continues for a same duration.

In FIGS. 3B-3D, each rectangular bar indicates the presence of a corresponding group of electron beamlet, with a reference number (one of 0, 1, 2, and 3) indicating which group the rectangular bar represents. In FIGS. 3B-3D, each rectangular bar has a pulse width T (as indicated in FIG. 3B). In some embodiments, pulse width T ranges from 1 nanoseconds (ns) to 10 ns. In some embodiments, pulse width T is set based on the sensitivity of the detectors. In some embodiments, the objective lens set converts the electron beam into the groups of electron beamlets such that each one of the groups of electron beamlets temporally begins at a different time.

FIG. 3B is a timing diagram of a first example arrangement 320 of the electron beamlets. In first example arrangement 320, within one scanning cycle, the groups of electron beamlets are sequentially arranged with adjacent groups separated by corresponding time gaps in the time domain. In this example, a time gap between two adjacent groups of electron beamlets is measurable based on an ending time of one group of electron beamlets to a starting time of a subsequent group of electron beamlets. In first example arrangement 320, adjacent groups are separated by corresponding time gaps of a duration of τ1 that is greater than zero. In some embodiments, the positive time gap τ1 is set to ensure sufficient separation and processing time for processing the signals of received backscattered electrons resulting from different groups of electron beamlets.

FIG. 3C is a timing diagram of a second example arrangement 330 of the electron beamlets. In second example arrangement 330, within one scanning cycle, the groups of electron beamlets are sequentially arranged one group immediately after another group in the time domain. In second example arrangement 330, adjacent groups have time gaps (as defined based on an ending time of one group of electron beamlets to a starting time of a subsequent group of electron beamlets) of a duration of τ2 that is zero. In some embodiments, in comparison with first example arrangement 320 and depending on the capability of timely processing the signals of received backscattered electrons, second example arrangement 330 is a feasible option with the benefit of a shorter scanning cycle.

FIG. 3D is a timing diagram of a third example arrangement 340 of the electron beamlets. In third example arrangement 340, within one scanning cycle, the groups of electron beamlets are sequentially arranged with adjacent groups partially overlapping each other in the time domain. In third example arrangement 340, adjacent groups have time gaps (as defined based on an ending time of one group of electron beamlets to a starting time of a subsequent group of electron beamlets) of a duration of τ3 that is less than zero. In some embodiments, in comparison with first example arrangement 320 and second example arrangement 330 and depending on the capability of separating the signals of received backscattered electrons from cross-talk noise, third example arrangement 340 is also a feasible option with the benefit of an even shorter scanning cycle.

In some embodiments, depending on different arrangements of the electron beamlets modes in the time domain as illustrated in FIGS. 3B-3D, the signals at the detectors are still separable or expected to be separable by a suitable signal processing algorithm. In some embodiments, the time gap τ1 or τ3 is constant or is dynamically adjustable. In some embodiments, the electron beam inspection device is configured such that each portion of the target area is still expected to receive equal electron dosage per scanning cycle.

Accordingly, an objective lens set of an electron beam inspection device is configured to convert a primary electron beam into a plurality of electron beamlets based on the examples in FIGS. 3A-3D separating the presence of neighboring beamlets in the time domain in order to reduce the chance of causing cross-talk noise. Also, based on the reduced cross-talk noise, the distance between the detectors and the sample is kept sufficiently away from the sample (e.g., a distance greater than 0.5 millimeters) in order to reduce the chance of arcing between the detectors and the sample without sacrificing the imaging quality.

FIGS. 2A-2C include a non-limiting example of reducing cross-talk noise based on a detector having an array of tilted sensing cells (i.e., the first concept). FIGS. 3A-3D include non-limiting examples of reducing cross-talk noise based on an objective lens set converting a primary electron beam into multiple groups of electron beamlets that are spatially interleaved and temporally distinguishable with respect to one another (i.e., the second concept). In some embodiments, an electron beam inspection device is configured to incorporate the teaching of the example in FIGS. 2A-2C, the teaching of the examples in FIGS. 3A-3D, or both, in order to reduce the cross-talk noise and/or avoid or reduce the arcing effects between the detectors and the sample.

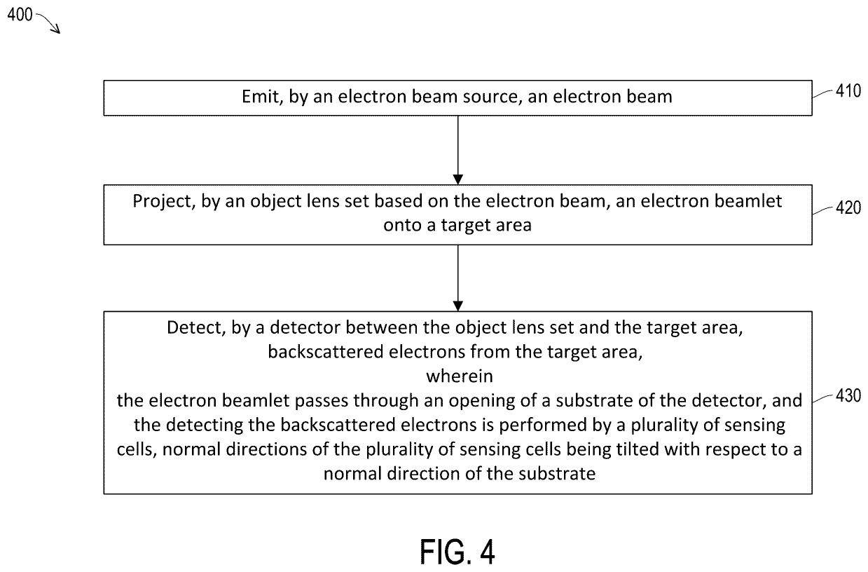

FIG. 4 is a flowchart of a method of inspection 400, in accordance with some embodiments. In some embodiments, various operations of method 400 are performed in conjunction with electron beam inspection device 100 in FIG. 1 with the plurality of detectors 140 implemented based on the example in FIGS. 2A-2C. As in FIG. 4, method 400 corresponds to an example based on the first concept and includes blocks 410-430.

At block 410, an electron beam source (e.g., electron beam source 110 in FIG. 1) emits an electron beam (e.g., electron beam 162 in FIG. 1). In some embodiments, the energy of the electron beam is at or greater than 3000 eV.

At block 420, an objective lens set (e.g., objective lens set 130 in FIG. 1) projects, based on the electron beam, at least an electron beamlet (e.g., plurality of electron beamlets 166 in FIG. 1) onto a target area (e.g., target area 152 in FIG. 1). In some embodiments, the objective lens set includes a plurality of MEMS devices configured as deflecting devices or beam stopping devices in association with the plurality of electron beamlets. In some embodiments, each one of the MEMS devices is associated with a corresponding electron beamlet and includes one or more layers of limiting apertures, an electron deflector, a stigmator, or a combination thereof.

At block 430, a detector (e.g., one of the plurality of detectors 140, based on the detector example 210 in FIGS. 2A-2B with sensing cells based on the sensing cell example 246 in FIG. 2C between the objective lens set and the target area, detects backscattered electrons (e.g., backscattered electrons 214 in FIG. 2A) from the target area. In some embodiments, the electron beamlet (e.g., electron beamlet 212) passes through an opening (e.g., opening 244) of a substrate (e.g., substrate 242) of the detector. In some embodiments, the detection of the backscattered electrons is performed by a plurality of sensing cells of the detector, and normal directions of the sensing cells (e.g., direction 248 in FIGS. 2A and 2C) are tilted with respect to a normal direction (e.g., normal direction 249 in FIGS. 2A and 2C) of the substrate.

In some embodiments, the detector is spaced apart from the target area by at least 0.5 millimeters. In some embodiments, the method 400 further includes blocking, by at least an insulating seal (e.g., insulating seal 266 in FIG. 2C) covering a side portion of a sensing cell of the detector and covering a back surface of the sensing cell of the detector, at least another backscattered electrons (e.g., backscattered electrons 226) resulting from another electron beamlet (e.g., electron beamlet 222).

As discussed in the example of FIGS. 2A-2C, based on the method 400, the cross-talk noise detected by the detector (e.g., detector 210) of the electron beam inspection device is reduced. Also, based on the reduced cross-talk noise, the distance between the detectors and the sample is kept sufficiently away from the sample (e.g., a distance greater than 0.5 millimeters) in order to reduce the chance of arcing between the detectors and the sample without sacrificing the imaging quality.

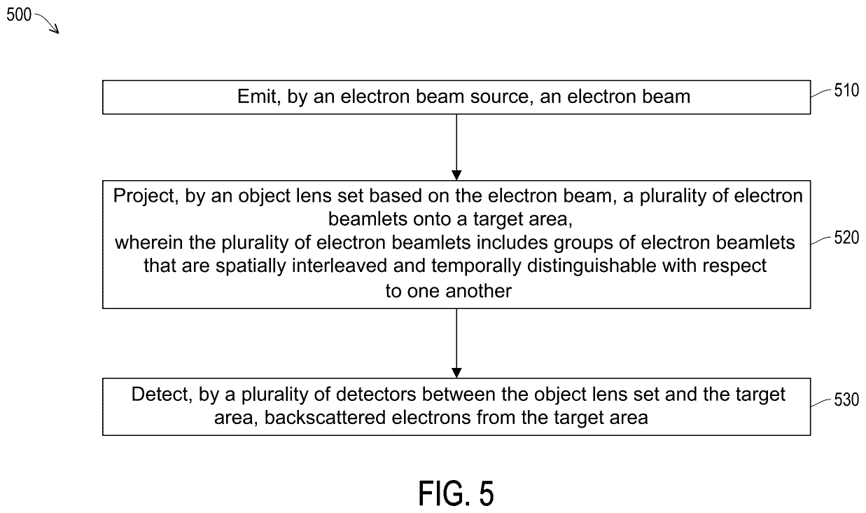

FIG. 5 is a flowchart of another method 500 of inspection, in accordance with some embodiments. In some embodiments, various operations of method 500 are performed in conjunction with electron beam inspection device 100 in FIG. 1 with the objective lens set 130 implemented based on the examples in FIGS. 3A-3D. As in FIG. 5, method 500 corresponds to examples based on the second concept and includes blocks 510-530.

At block 510, an electron beam source (e.g., electron beam source 110 in FIG. 1) emits an electron beam (e.g., electron beam 162 in FIG. 1). In some embodiments, the energy of the electron beam is at or greater than 3000 eV.

At block 520, an objective lens set (e.g., objective lens set 130 in FIG. 1) projects, based on the electron beam, a plurality of electron beamlets (e.g., plurality of electron beamlets 166 in FIG. 1) onto a target area (e.g., target area 152 in FIG. 1). At block 530, a plurality of detectors (e.g., the plurality of detectors 140) between the objective lens set and the target area, detects backscattered electrons from the target area.

In some embodiments, the objective lens set includes a plurality of MEMS devices configured as deflecting devices or beam stopping devices in association with the plurality of electron beamlets. In some embodiments, each one of the MEMS devices is associated with a corresponding electron beamlet and includes one or more layers of limiting apertures, an electron deflector, a stigmator, or a combination thereof. In some embodiments, based on the examples in FIGS. 3A-3D, the plurality of electron beamlets includes groups of electron beamlets that are spatially interleaved and temporally distinguishable with respect to one another.

In some embodiments, the objective lens set converts the electron beam into the electron beamlets that are spatially arranged based on positions of a plurality of detectors, where the plurality of detectors is arranged based on a hexagon honeycomb pattern (e.g., the hexagon honeycomb pattern in FIG. 3A). In some embodiments, the groups of electron beamlets correspond to four groups (e.g., group ‘0’, group ‘1’, group ‘2’, and group ‘3’ in FIG. 3A). In some embodiments, at least one electron beamlet of each one of the four groups is spatially surrounded by six electron beamlets of the other three of the four groups.

In some embodiments, the objective lens set converts the electron beam into the groups of electron beamlets such that each one of the groups of electron beamlets temporally begins at a different time. In some embodiments, the groups of electron beamlets are sequentially arranged with adjacent groups separated by corresponding time gaps in a time domain. In some embodiments, the groups of electron beamlets are sequentially arranged one group immediately after another group in the time domain. In some embodiments, the groups of electron beamlets are sequentially arranged with adjacent groups partially overlapping each other in the time domain.

As discussed in the example of FIGS. 3A-3D, based on the method 500, the cross-talk noise detected by the detector (e.g., detector 210) of the electron beam inspection device is reduced. Also, based on the reduced cross-talk noise, the distance between the detectors and the sample is kept sufficiently away from the sample (e.g., a distance greater than 0.5 millimeters) in order to reduce the chance of arcing between the detectors and the sample without sacrificing the imaging quality.

In some aspects, an inspection apparatus includes an electron beam source configured to emit an electron beam. The inspection apparatus includes an objective lens set configured to project, based on the electron beam, an electron beamlet onto a target area. The inspection apparatus further includes a detector between the objective lens set and the target area and configured to detect backscattered electrons beamlets from the target area. The detector includes a substrate having an opening through which the electron beamlet passes, a plurality of sensing cells disposed on the substrate and surrounding the opening. Each sensing cell of the plurality of sensing cells has a normal direction tilted with respect to a normal direction of the substrate.

In some aspects, an inspection apparatus includes an electron beam source configured to emit an electron beam. The inspection apparatus includes an objective lens set configured to project, based on the electron beam, a plurality of electron beamlets onto a target area. The inspection apparatus further includes a plurality of detectors between the objective lens set and the target area and configured to detect backscattered electrons from the target area. The plurality of electron beamlets includes groups of electron beamlets that are spatially interleaved and temporally distinguishable with respect to one another.

In some aspects, a method of inspection includes emitting, by an electron beam source, an electron beam. The method includes projecting, by an objective lens set based on the electron beam, an electron beamlet onto a target area. The method further includes detecting, by a detector between the objective lens set and the target area, backscattered electrons from the target area. The electron beamlet passes through an opening of a substrate of the detector. The detecting the backscattered electrons is performed by a plurality of sensing cells of the detector, normal directions of the plurality of sensing cells being tilted with respect to a normal direction of the substrate.

In some aspects, a method of inspection includes emitting, by an electron beam source, an electron beam. The method includes projecting, by an objective lens set based on the electron beam, a plurality of electron beamlets onto a target area. The method further includes detecting, by a plurality of detectors between the objective lens set and the target area, backscattered electrons from the target area. The plurality of electron beamlets includes groups of electron beamlets that are spatially interleaved and temporally distinguishable with respect to one another.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure and that they may make various changes, substitutions, and alterations herein without departing from the spirit and scope of the present disclosure.

What is claimed is:

1. An inspection apparatus, comprising:
an electron beam source configured to emit an electron beam;
an objective lens set configured to project, based on the electron beam, an electron beamlet onto a target area; and
a detector between the objective lens set and the target area and configured to detect backscattered electrons from the target area, the detector comprising:
a substrate having an opening through which the electron beamlet passes; and
a plurality of sensing cells disposed on the substrate and surrounding the opening, each sensing cell of the plurality of sensing cells has a normal direction tilted with respect to a normal direction of the substrate.

2. The inspection apparatus of claim 1, wherein
the substrate is divided into zones surrounding the opening, and
the plurality of sensing cells has subsets of sensing cells disposed in corresponding ones of the zones in a rotationally symmetric manner with respect to the opening.

3. The inspection apparatus of claim 1, wherein
the electron beamlet passes through the opening along an axis, and
each sensing cell of the plurality of sensing cells has a sensing surface facing the target area and tilted toward the axis.

4. The inspection apparatus of claim 1, each sensing cell of the plurality of sensing cells comprises:
a sensing diode having a sensing surface at a front portion of the corresponding sensing cell;
a signal pick-up circuit at a back portion of the corresponding sensing cell; and
an insulating seal covering a side portion of the corresponding sensing cell.

5. The inspection apparatus of claim 4, wherein, for each sensing cell of the plurality of sensing cells,
a gap is defined between the substrate and a back surface of the signal pick-up circuit of the corresponding sensing cell, and
the insulating seal extends into the gap and covers the back surface of the signal pick-up circuit of the corresponding sensing cell.

6. The inspection apparatus of claim 4, wherein, for each sensing cell of the plurality of sensing cells,
the signal pick-up circuit comprises an amplification circuit or an operational amplifier, and
the insulating seal comprises a material including silicon oxide, silicon nitride, polymer, ceramic, epoxy, or a combination thereof.

7. An inspection apparatus, comprising:
an electron beam source configured to emit an electron beam;
an objective lens set configured to project, based on the electron beam, a plurality of electron beamlets onto a target area; and
a plurality of detectors between the objective lens set and the target area and configured to detect backscattered electrons from the target area,
wherein the plurality of electron beamlets includes groups of electron beamlets that are spatially interleaved and temporally distinguishable with respect to one another.

8. The inspection apparatus of claim 7, wherein
the objective lens set comprises a plurality of microelectron-mechanical system (MEMS) devices configured as deflecting devices or beam stopping devices in association with the plurality of electron beamlets.

9. The inspection apparatus of claim 7, wherein
the plurality of detectors is arranged based on a hexagon honeycomb pattern,
the objective lens set is configured to convert the electron beam into the electron beamlets that are spatially arranged based on centers of the hexagon honeycomb pattern,
the groups of electron beamlets correspond to four groups, and
at least one electron beamlet of each one of the four groups is spatially surrounded by six electron beamlets of the other three of the four groups.

10. The inspection apparatus of claim 7, wherein
the objective lens set is configured to convert the electron beam into the groups of electron beamlets such that each one of the groups of electron beamlets temporally begins at a different time.

11. The inspection apparatus of claim 10, wherein
the groups of electron beamlets sequentially begin one after another and sequentially end one after another, and
each one of the groups of electron beamlets temporally continues for a same duration.

12. The inspection apparatus of claim 10, wherein
the groups of electron beamlets are sequentially arranged with adjacent groups separated by corresponding time gaps in a time domain,
the groups of electron beamlets are sequentially arranged one group immediately after another group in the time domain, or the groups of electron beamlets are sequentially arranged with adjacent groups partially overlapping each other in the time domain.

13. A method of inspection, comprising:
emitting, by an electron beam source, an electron beam;
projecting, by an objective lens set based on the electron beam, a plurality of electron beamlets onto a target area; and
detecting, by a plurality of detectors between the objective lens set and the target area, backscattered electrons from the target area,
wherein the plurality of electron beamlets includes groups of electron beamlets that are spatially interleaved and temporally distinguishable with respect to one another.

14. The method of claim 13, further comprising:
converting, by the objective lens set, the electron beam into the electron beamlets that are spatially arranged based on positions of the plurality of detectors,
wherein
the plurality of detectors is arranged based on a hexagon honeycomb pattern,
the groups of electron beamlets correspond to four groups, and
at least one electron beamlet of each one of the four groups is spatially surrounded by six electron beamlets of the other three of the four groups.

15. The method of claim 13, further comprising:
converting, by the objective lens set, the electron beam into the groups of electron beamlets such that each one of the groups of electron beamlets temporally begins at a different time.

16. The method of claim 15, wherein
the groups of electron beamlets are sequentially arranged with adjacent groups separated by corresponding time gaps in a time domain,
the groups of electron beamlets are sequentially arranged one group immediately after another group in the time domain, or
the groups of electron beamlets are sequentially arranged with adjacent groups partially overlapping each other in the time domain.

17. The method of claim 13, wherein
the plurality of detectors is spaced apart from the target area by at least 0.5 millimeters.

18. The method of claim 13, wherein
one of the plurality of electron beamlets passes through an opening of a substrate of a corresponding one of the plurality of detectors, and
the detecting the backscattered electrons in association with the one of the plurality of electron beamlets is performed by a plurality of sensing cells of the one of the plurality of detectors, normal directions of the plurality of sensing cells being tilted with respect to a normal direction of the substrate.

19. The method of claim 18, further comprising:
blocking, by at least an insulating seal covering a side portion and a back surface of a sensing cell of the one of the plurality of detectors, at least another backscattered electrons resulting from another one of the plurality of electron beamlets.

20. The method of claim 18, wherein
the one of the plurality of electron beamlets through the opening along an axis, and
each sensing cell of the plurality of sensing cells has a sensing surface facing the target area and tilted toward the axis.
